(19) United States
(12) Patent Application Publication
(10) Pub. No.: US 2010/0022417 A1
(43) Pub. Date: Jan. 28, 2010

(54) Composition and Method for the Removal or Control of Paraffin Wax and/or Asphaltine Deposits

(76) Inventor: John P. Acunto, Hollywood, FL (US)

Correspondence Address: C. JAMES BUSHMAN, 5851 San Felipe, SUITE 975, HOUSTON, TX, 77057, US

(21) Appl. No.: 12/442,025

(22) PCT Filed: Aug. 24, 2007
(86) PCT No.: PCT/US07/18774

§ 371 Date: Mar. 19, 2009

(51) Int. Cl. C09K 8/524

(52) U.S. Cl. 507/90

(57) ABSTRACT

A composition for removing and/or controlling build up of paraffin waxes and/or asphaltines from surfaces comprising from 0.1 to 99% by weight of a terpene and from 0.1 to 99% by weight of a hydrocarbon solvent containing from 60 to 70% by weight of a paraffin component, from 30 to 40% by weight of a naphthenic component and less than 2% by weight aromatics.

### FIELD OF THE INVENTION

The present invention relates to a composition and method for the removal and/or control of paraffin wax deposits and/or asphaltines present in formation fluids.

### BACKGROUND OF THE INVENTION

Many formation fluids such as petroleum fluids, e.g., crude oil, contain a large number of components with complex structures. For the purposes of the present invention, a formation fluid is a product from an oil well from the time it is produced until it is refined. Some of the components present in the formation fluid, for example, paraffin wax (wax) and asphaltines, are normally solids under ambient conditions, particularly at ambient temperatures and pressures. Wax is comprised predominantly of high molecular weight paraffinic hydrocarbons, i.e., alkanes, while asphaltines are typically dark brown to black colored amorphous solids with complex structures and relatively high molecular weight. In addition to carbon and hydrogen, asphaltines can also contain nitrogen, oxygen and sulphur species. Typical asphaltines are known to have some solubilities in the formation fluid itself or in certain solvents like carbon disulphide, but are insoluble in other solvents, for example, light naphtha.

When the formation fluid from a subsurface formation comes into contact with a pipe, valve or other production equipment of a wellbore, or when there is a decrease in temperature, pressure, or change of other conditions, waxes and/or asphaltines may precipitate or separate out of a well stream or the formation fluid while flowing into and through the wellbore to the wellhead. While precipitation of any waxes or asphaltines is undesirable in and by itself, it is much worse to allow such precipitants to accumulate by sticking to the equipment in the wellbore or plugging the wellbore. Any such precipitants sticking to the wellbore surfaces may narrow pipes, and clog wellbore perforations, various flow valves, and other well site and downhole equipment. This may result in well site equipment failures. It may also slow down, reduce or even totally prevent the flow of formation fluid into the wellbore and/or out of the wellhead.

Similarly undetected precipitations and accumulations of waxes and asphaltines in a pipeline for transferring crude oil could result in loss of oil flow and/or equipment failure. Crude oil storage facilities could have maintenance or capacity problems if these precipitants remain undetected for an extended period of time.

As a result of these potential problems, during oil production in production wells, the drilling of new wells or workovers on existing wells, many chemicals, or “additives”, including solvents, are often injected from a surfade source into the wells to treat the formation fluids flowing through such wells to dissolve, prevent or control the precipitation of the waxes and/or asphaltines. In addition to controlling precipitation of the waxes and asphaltines, additives are also injected into producing wells to, among other things, enhance production to the wellbore, lubricate downhole equipment, or to control corrosion, scale, emulsion formation and hydrate formation.

Typically these chemicals or additives are injected through a conduit or tubing that is run from the surface to a known depth.

In an attempt to minimize buildup of waxes, asphaltines and similar heavy components present in crude oil and other formation fluids, typically four prior art methods have been employed. The first method uses aggressive blends of aromatic and/or aliphatic petroleum hydrocarbons or halogenated hydrocarbons. These products may or may not contain surfactants to allow the products to mix with and emulsify in water to increase cleaning efficiency. The presence of water decreases the efficiencies of these compositions significantly. Pure solvent blends are immissible in water and cannot penetrate to the soils in the formation. The addition of emulsifiers allows the solvents to blend with the water, but the resulting solvent/emulsion system is not as efficient a cleaner as the pure solvent.

The second method is the use of bacteria to digest the paraffinic and/or asphaltine materials. This system is very dependent on well temperature and is sensitive to environmental factors such as the composition of the crude oil. This process is typically slower than the solvent-based process.

A third method is predicated on water-based alkaline, hard surface cleaners. These cleaners generally incorporate alkaline builders, water soluble solvents, such as glycol ethers, alcohols, and surfactants. Alkaline builders consist of hydroxides, carbonates, phosphates, and silicates. Water soluble solvents typically consist of ethylene glycol, di-ethylene glycol, propylene glycol and di-propylene glycol ethers. Typical surfactants comprise alkyl phenol ethoxylates, linear alcohol ethoxylates, or alkyl sulphonates, amphoterics, and fatty acid soaps of alkanolamides. The cleaning efficiency of these alkaline compositions on waxes and/or asphaltine-type materials is typically much lower than that of solvent blends.

The fourth method of cleaning involves the use of hot oil, which is injected into the well. The hot oil melts and dissolves the paraffins and to a lesser extent the asphaltines and carries them to the surface. Although this method is efficient in terms of dissolving the deposits, the use of hot oil creates a hazardous condition, can adversely affect the wells, is time consuming and expensive.

As noted, typical prior art compositions for treating wax and/or alphatic formation or build up employ solvents of aromatic and/or aliphatic petroleum hydrocarbons or hologenated hydrocarbons. These solvents produce vapor emissions, commonly known as “VOCs” (volatile organic compounds), which typically are toxic. Other cleaning compositions require little or no VOCs but require high levels of caustic and/or phosphate which cause problems in transportation, use, and disposal.

There are many problems associated with the above-mentioned methods and solvents. For example, halogenated hydrocarbons affect worker health adversely and are ozone depleting chemicals. Some of the solvents and methods may adversely affect the quality of the oil or gas. Many of the non-halogenated solvents are either flammable or combustible, resulting in increased fire and explosion risks and higher insurance premiums. Furthermore, the disposal of the spent solvents in accordance with government regulations is expensive.

### SUMMARY OF THE INVENTION

In one aspect the present invention provides a composition and method for the deposition, removal and/or control of wax and/or asphaltine buildups and blockages whether in downhole formations, downhole equipment, surface equipment and/or downstream equipment, e.g., refinery equipment.

In another aspect the present invention provides a composition comprising from 0.1 to 99.9% by weight of a terpene selected from the group consisting of d-limonene, alpha-pinene, beta-pinene and mixtures thereof, and from 0.1 to 99.9% by weight of a hydrocarbon solvent containing from 60 to 70% by weight of a paraffin component, from 30 to 40% by weight of a naphthenic component and less than about 2% by weight aromatics. The hydrocarbon solvent can have an average molecular weight of from 170 to 200.

In yet another aspect of the present invention there is provided a method for controlling and/or removing buildup of waxes and/or asphaltines derived from formation fluids wherein the composition above is injected into a wellbore where the injection can include injecting the composition into the formation of a producing well, circulating the formation through the production tubing, treating the wellhead to remove deposits from valves, chokes and the like, or introducing the composition into a flow line leading from the wellhead into a gathering system including to the piping, valves, etc. of a refinery.

The foregoing objects, features and advantages of the present invention, as well as others, will be more fully understood and better appreciated by reference to the following specification and claims.

### DETAILED DESCRIPTION OF PREFERRED EMBODIMENTS

The composition of the present invention comprises a terpene and a hydrocarbon solvent. The terpene is one selected from the group consisting of d-limonene, alpha-pinene, beta-pinene and mixtures thereof. The hydrocarbon solvent comprises from 60 to 70% by weight of a paraffin component, from 30 to 40% by weight of a naphthenic component and less than 2% by weight aromatics, preferably less than 1% by weight aromatics. The hydrocarbon solvent can have an average molecular weight of 170 to 200.

The relative amount of the terpene and the hydrocarbon solvent will vary depending upon whether the material to be dissolved and/or controlled is all or primarily wax, all or primarily asphaltines, or a mixture thereof.

The terpenes useful in the present invention are unsaturated hydrocarbons occurring in most essential oils and oleo resins. They may be either acyclic or cyclic. The terpenes useful in the present invention are d-limonene, alpha-pinene, beta-pinene and mixtures thereof, d-limonene being preferred. D-limonene is a well known byproduct of the citrus industry derived from the distilled rind oils of oranges, grapefruits, lemons and other citrus fruit. The terpenes, particular d-limonene, exhibit low human toxicity and are considered environmentally benign. D-limonene is commercially available from a number of sources.

The hydrocarbon solvents used in the present invention can be generically characterized as high-purity mixtures of hydrotreated isoparaffins and naphthenics with very low levels of aromatics. Such solvents are clear liquids with mild odor and high solvency. One source of hydrocarbon solvents suitable in the present invention is Sasol North America Inc. which sells hydrocarbon solvents under the trade name LPA® Solvents. These LPA® Solvents are produced in a process which minimizes the level of normal paraffins in the solvents. Generally speaking the hydrocarbon solvents useful in the present invention will contain from 60 to 70% by weight of a paraffin component which is at least 95% by weight isoparaffin, preferably at least 98% by weight isoparaffin, from 30 to 40% by weight of a naphthenic component and less than 2%, preferably less than 1% by weight, aromatics. The hydrocarbon solvents useful will have a molecular weight of from 170 to 200. Generally speaking the hydrocarbon solvents will have a flash point (TAG Closed Cup, ° F.) of greater than 156, preferably greater than about 170. A particularly preferred hydrocarbon solvent useful in the present invention is sold by Sasol North America Inc. under the trademark LPA®-210 Solvent. LPA®-210 Solvent has an initial boiling point of 464° F. and an end point of 536° F. with a molecular weight of 193. LPA®-210 Solvent contains about 65% of the paraffinic component, about 35% of the naphthenic component and about 1% of the aromatic component, where all percentages are by weight.

As noted above, the relative amounts of the terpene, especially the d-limonene, and the hydrocarbon solvent can vary over wide limits and can be tailored to meet specific applications, the type of deposit, e.g., waxes, asphaltines or a mixture thereof, the location where the composition is to be employed, e.g., downhole, upstream from the wellhead, etc. For example, if the material is all or primarily wax, a preferred composition could comprise from about 35 to about 99.9% by weight d-limonene and from about 0.1 to about 65% hydrocarbon solvent, e.g., LPA® 210. Similarly, in the case where the deposit was primarily asphaltine, a preferred composition would be from about 3.5 to about 99.9% d-limonene and from about 0.1 to about 65% hydrocarbon solvent. In the case where the deposit is a mixture of both wax and asphaltine, e.g., from 30 to 70% by weight wax and from 30 to 70% by weight asphaltine, a preferred composition would be from about 20 to about 99.9% by weight d-limonene and from about 0.1 to about 80% by weight hydrocarbon solvent, more preferably from about 30 to about 99.9% by weight d-limonene and from about 0.1 to about 70% by weight hydrocarbon solvent. As a general rule, a composition containing from about 25 to about 40% d-limonene and from about 60 to about 75% hydrocarbon solvent works well on formation fluid deposits whether it be primarily wax, primarily asphaltene or a mixture thereof.

As noted above, the composition of the present invention can be used in downhole environments all the way to refinery operations. In the case of downhole operations, the composition can be used to unplug or dissolve deposits in the downhole formations. In this case, the composition would be pumped through the production tubing into the formation under pressure sufficient to force the composition into the formation. Depending upon the degree of deposition or buildup in the formation, a suitable residence time of the composition in the formation would be necessary in order to dissolve and/or at least fluidize the buildup in the formation. During the time that the composition was in the formation, oil and/or solvent could be circulated through the tubing string to prevent any deposits or buildup in the tubing. Once the composition had been in contact with the formation for a sufficient period of time, production can be resumed. It should be noted that as production is resumed and assuming that the composition is not totally saturated with wax and/or asphaltine, it would also have a beneficial effect on the wellhead valves and other equipment. Furthermore, since the composition is hydrocarbon in nature it can be sent to a refinery or other processing facility without creating any problems vis-à-vis catalyst poisoning, etc. Indeed it can aid in preventing and/or receiving formation fluid deposits from gathering systems transportation pipe line and refining piping, valves, etc.

If it is desired simply to circulate a composition in the tubing, it can be injected at the wellhead or alternately through an injection string inserted into the production tubing. It will also be appreciated that the composition can be circulated from the annulus between the tubing and the casing through the tubing on a batch or continuous basis. It is also possible in gas lift scenarios to atomize or spray the composition under pressure through the annulus into the tubing. Coiled tubing units can be utilized to inject the composition as well.

In offshore applications, it is typical for production wells to have chemical injection strings which typically run outside the casing, particularly in deep water wells. These chemical injection streams could be used to inject the composition through the subsea tree and into the formation.

It will be understood that when using the composition to correct deposition buildup, plugging, etc., in downhole formations or downhole equipment, the parameters of the well would have to be considered so as to use the minimum amount of the composition to obtain optimal results.

It is also contemplated that the composition of the present invention can be used to reduce plugging in water injection wells such that produced water can be removed from the well. Again, this technique as well as the other techniques discussed above can be done either by batch or a continuous basis.

In general, in treating downhole formations or downhole equipment, any technique commonly used to reduce wax and/or asphaltine deposits can be employed including fracing techniques.

To more illustrate the present invention, the following non-limiting examples are presented:

In the following examples, the procedure employed was ASTM Method D2042 (MOD). In this ASTM method, a given weight of sample (wax and/or asphaltine) is weighed in a flask and 100 ml of the composition added to the flask. The flask is then placed in 140° F. water bath for 30 minutes. Following this the flasks are removed from the water bath and the samples are filtered through pre-weighted Gooch crucibles having a 32 mm glass microfiber filter. The crucibles are then placed in a 100° F. oven for 30 minutes following which they are removed from the oven, cooled and weighed. In the examples which follow, the wax and asphaltine chosen were considered to be of a difficult type to dissolve.

The wax (paraffin) used came from a Hancock County, Tenn. well identified as Paul Reed #2 and had a pour point of 149.5° F., a melting point of 162.5° F. and a boiling range of about 1204° F.-1382° F. This is characteristic of a paraffin that is hard and typically of a type which is difficult to dissolve. in the case of the asphaltines, the samples were obtained from a South American crude that had been distilled to a 1050° F. end point. Thus the asphaltine used had a boiling point of 1050° F. and higher. It contained about 40% by weight asphaltine which is typical of high asphaltines crude oil.

In this example and all other examples, all percents are by weight unless otherwise indicated and all weights are in grams unless otherwise indicated.

### Example 1

This example demonstrates the ability of a solvent of the present invention to dissolve the paraffin. A series of samples containing various amounts of d-limonene and LPA®-210 were admixed with approximately 2 grams of wax and the solubility determined as described above. The data is shown in Table 1 below.

TABLE 1

| | | | | % | |
|---|---|---|---|---|---|
| | D-limonene | LPA-210 | Sample Weight | Insoluble | % Soluble |
| 1 | 5% | 95% | 2.0127 | 9.93 | 90.07 |
| 2 | 15% | 85% | 2.0573 | 3.29 | 96.71 |
| 3 | 25% | 75% | 2.0149 | 8.48 | 91.52 |
| 4 | 35% | 65% | 1.9355 | 3.66 | 96.34 |
| 5 | 45% | 55% | 1.9821 | 4.72 | 95.28 |
| 6 | 55% | 45% | 2.1794 | 3.57 | 96.43 |
| 7 | 65% | 35% | 1.9361 | 2.11 | 97.89 |
| 8 | 75% | 25% | 2.1196 | 0.98 | 99.02 |
| 9 | 85% | 15% | 1.9861 | 0.73 | 99.27 |
| 10 | 95% | 5% | 2.0543 | 0.56 | 99.44 |

As can be seen from the data in Table 1, while virtually any combination of d-limonene and LPA®-210 is effective at dissolving a large amount of wax, a composition wherein the d-limonene is present in an amount of from about 35 to about 99.9% by weight and hydrocarbon solvent is present in an amount of from about 0.1 to about 65% by weight is particularly effective.

### Example 2

This example demonstrates the ability of the composition of the present invention to dissolve the asphaltine as described above. The procedure of Example 1 was followed with the exception that asphaltine was substituted for wax. The results are shown in Table 2 below.

TABLE 2

| | D-limonene | LPA-210 | Sample Weight | % Insoluble | % Soluble |
|---|---|---|---|---|---|
| 1 | 5% | 95% | 2.1236 | 15.87 | 84.13 |
| 2 | 15% | 85% | 1.8304 | 6.90 | 93.10 |
| 3 | 25% | 75% | 1.936 | 2.17 | 97.83 |
| 4 | 35% | 65% | 1.9606 | 1.63 | 98.37 |
| 5 | 45% | 55% | 1.5042 | 1.33 | 98.67 |
| 6 | 55% | 45% | 2.1749 | 1.26 | 98.74 |
| 7 | 65% | 35% | 2.1396 | 0.55 | 99.80 |
| 8 | 75% | 25% | 1.8815 | 0.20 | 99.82 |
| 9 | 85% | 15% | 1.957 | 0.18 | 99.89 |
| 10 | 95% | 5% | 1.9678 | 0.13 | 99.95 |

As can be seen from the data in Table 2, the compositions of the present invention at virtually all relative amounts of d-limonene and LPA®-210 is a highly effective solvent for an asphaltine. However, as can be seen, a composition comprising from about 3.5 to about 99.9% by weight d-limonene and from about 0.1 to about 65% by weight hydrocarbon solvent is especially effective.

### Example 3

This example demonstrates the ability of the composition of the present invention to dissolve a mixture of wax and asphaltine. Again, the procedure of Example 1 was followed with the exception that the sample employed was a mixture of the asphaltine (A) and wax (P). The results are shown in Table 3 below.

TABLE 3

| | | | | % | |
|---|---|---|---|---|---|
| | D-limonene | LPA-210 | Sample Weight | Insoluble | % Soluble |
| 1 | 5% | 95% | A 0.21 g | 3.0% | 97.0% |
| | | | P 0.24 g | | |
| 2 | 15% | 85% | A 0.22 g | 2.0% | 98.0% |
| | | | P 0.25 g | | |
| 3 | 25% | 75% | A 0.21 g | 0.75% | 99.25% |
| | | | P 0.26 g | | |
| 4 | 35% | 65% | A 0.23 g | 0.26 | 99.74% |
| | | | P 0.55 g | | |
| 5 | 45% | 55% | A 0.23 g | 0.30% | 99.70% |
| | | | P 0.26 g | | |
| 6 | 55% | 45% | A 0.24 g | 0.34% | 99.66% |
| | | | P 0.32 g | | |
| 7 | 65% | 35% | A 0.22 g | 0.13% | 99.87% |
| | | | P 0.47 g | | |
| 8 | 75% | 25% | A 0.22 g | 0.11% | 99.89% |
| | | | P 0.40 g | | |
| 9 | 85% | 15% | A 0.24 g | 0.19% | 99.81% |
| | | | P 0.44 g | | |
| 10 | 95% | 5% | A 0.24 g | 0.19% | 99.81% |
| | | | P 0.35 g | | |

As can be seen from the data in Table 3 above, virtually all relative amounts of d-limonene and hydrocarbon solvent are highly effective at dissolving the wax/asphaltine mixture. However, as can be further seen from Table 3, compositions comprising from about 20 to about 99.1% by weight d-limonene and from about 0.1 to about 80% by weight hydrocarbon solvent are quite effective.

### Example 4

The procedure of Example 3 was followed with the exception that higher weights of the wax/asphaltine mixture were employed. The data is shown in Table 4 below.

TABLE 4

| | D-limonene | LPA-210 | Sample Weight | % Insoluble | % Soluble |
|---|---|---|---|---|---|
| 1 | 17% | 83% | A 1.06 g | 39.0% | 61.0% |
| | | | P 1.27 g | | |
| 2 | 20% | 80% | A 1.09 g | 32.8% | 67.2% |
| | | | P 1.07 g | | |
| 3 | 23% | 77% | A 0.97 g | 38.2% | 61.8% |
| | | | P 1.04 g | | |
| 4 | 26% | 74% | A 1.15 g | 30.5% | 69.5% |
| | | | P 1.11 g | | |
| 5 | 27% | 73% | A 1.02 g | 20.0% | 80.0% |
| | | | P 1.07 g | | |
| 6 | 28% | 72% | A 1.06 g | 8.9% | 91.1% |
| | | | P 1.16 g | | |
| 7 | 29% | 71% | A 1.02 g | 9.7% | 90.3% |
| | | | P 1.12 g | | |
| 8 | 30% | 70% | A 0.93 g | 18.4% | 81.6% |
| | | | P 1.07 g | | |
| 9 | 31% | 69% | A 0.95 g | 4.6% | 95.4% |
| | | | P 1.15 g | | |
| 10 | 32% | 68% | A 1.16 g | 16.7% | 83.3% |
| | | | P 1.33 g | | |
| 11 | 33% | 67% | A 0.94 g | 9.8% | 90.2% |
| | | | P 1.40 g | | |
| 12 | 34% | 66% | A 0.95 g | 3.4% | 96.6% |
| | | | P 1.02 g | | |
| 13 | 37% | 63% | A 1.05 g | 1.3% | 98.7% |
| | | | P 1.09 g | | |
| 14 | 40% | 60% | A 1.09 g | 1.4% | 98.6% |
| | | | P 1.31 g | | |
| 15 | 43% | 57% | A 1.04 g | 1.0% | 99.0% |
| | | | P 1.23 g | | |

As the data in Table 4 demonstrate, a particularly desirable composition for dissolving a mixture of wax and asphaltine contains any amount of d-limonene above 30% and up to about 99.9% by weight and any amount of hydrocarbon solvent from about 0.1 to about 70% by weight.

### Example 5

U.S. Pat. No. 6,197,734 teaches a heavy wax content, heavy oil remover comprising inter alia 1 to 90% by weight d-limonene and 1 to 90% by weight white oil. For comparative purposes the procedure of Example 1 was followed with the exception that white oil was substituted for the hydrocarbon solvent. The results are shown in Table 5 below.

TABLE 5

| | D-limonene | White Oil | Sample Weight | % Insoluble | % Soluble |
|---|---|---|---|---|---|
| 1 | 5% | 95% | 1.14 g | 28.7% | 71.3% |
| 2 | 15% | 85% | 1.89 g | 15.9% | 84.1% |
| 3 | 25% | 75% | 2.58 g | 10.9% | 89.1% |
| 4 | 35% | 65% | 1.15 g | 8.1% | 91.9% |
| 5 | 45% | 55% | 0.78 g | 7.2% | 92.8% |
| 6 | 55% | 45% | 1.15 g | 5.8% | 94.2% |
| 7 | 65% | 35% | 1.83 g | 2.5% | 97.5% |
| 8 | 75% | 25% | 2.34 g | 1.3% | 98.7% |
| 9 | 85% | 15% | 1.60 g | 1.0% | 99.0% |
| 10 | 95% | 5% | 1.52 g | 0.6% | 99.4% |

As can be seen from Table 5, the composition comprised of d-limonene and white oil has to contain at least 25% by weight d-limonene to be as effective at dissolving the wax as a composition, as shown in Table 1, containing as little as 5% d-limonene.

### Example 6

The procedure of Example 2 was followed with the exception that white oil was substituted for the hydrocarbon solvent. The results are shown in Table 6 below.

TABLE 6

| | D-limonene | White Oil | Sample Weight | % Insoluble | % Soluble |
|---|---|---|---|---|---|
| 1 | 5% | 95% | 1.23 g | Could not filter sample | |
| 2 | 15% | 85% | 1.40 g | Could not filter sample | |
| 3 | 25% | 75% | 0.61 g | 70.0% | 30.0% |
| 4 | 35% | 65% | 1.02 g | 48.6% | 51.4% |
| 5 | 45% | 55% | 0.30 g | 24.3% | 75.7% |
| 6 | 55% | 45% | 0.22 g | 28.4% | 71.6% |
| 7 | 65% | 35% | 0.19 g | 24.6% | 75.4% |
| 8 | 75% | 25% | 0.43 g | 7.2% | 92.8% |
| 9 | 85% | 15% | 0.15 g | 7.2% | 92.8% |
| 10 | 95% | 5% | 0.19 g | 4.0% | 96.0% |

As can be seen from the data in Table 6, when white oil is substituted for the hydrocarbon solvent of the present invention, it takes at least 75% by weight of d-limonene to cause significant dissolution of the asphaltine. This is to be contrasted with the data in Table 2 where when the composition of the present invention is employed with as little as 5% by weight d-limonene, virtually all of the asphaltine is dissolved. The data in Tables 5 and 6 clearly demonstrate that a mixture of d-limonene and the hydrocarbon solvent of the present invention is vastly superior to a combination of d-limonene and white oil terms of dissolving wax and/or asphaltines.

### Example 7

To demonstrate the effectiveness of either d-limonene or LPA® 210 alone in dissolving wax and asphalts, the procedure of Example 1 was followed. The results are shown in Table 7 below.

TABLE 7

| | | | Sample Weight | % Insoluble | % Soluble |
|---|---|---|---|---|---|
| | D-limonene | | | | |
| 1 | 100% | Paraffin | 0.43 g | 0.35% | 99.65% |
| 2 | 100% | Asphalt | 0.25 g | 0.16% | 99.84% |
| | LPA-210 | | | | |
| 1 | 100% | Paraffin | 0.32 g | <0.1% | >99.99% |
| 2 | 100% | Asphalt | 0.22 g | 35.0% | 65.0% |

As can be seen from the data in Table 7, d-limonene in and of itself is a highly effective solvent both for wax and asphaltines. As can be further seen, a hydrocarbon solvent of the present invention is highly effective for wax but is less effective than d-limonene at dissolving asphaltine.

### Example 8

To show the effectiveness of the composition of the present invention as compared to that of U.S. Pat. No. 6,197,734 in dissolving either wax or asphaltines, a composition as set forth in Table 1 of U.S. Pat. No. 6,197,734 was prepared. 100 ml of this composition was employed in the method set forth in Example 1 above both with respect to about 1 gram wax and 1 gram asphaltine. It was found that the composition set forth in Table 1 of U.S. Pat. No. 6,197,734 did not dissolve enough of the wax to be filtered using the ASTM method described above. The same was true of the asphaltine. This data is to be contrasted with the data in Tables 1 and 2 hereof where virtually all of the wax and asphaltines dissolved.

### Example 9

1.29 grams of wax was mixed with 100 ml of a commercially available composition used in treating paraffin and asphaltine deposits in downhole environments and marketed by Baker Hughes. The Baker Hughes composition contained greater than 50% by volume toluene. The mixture was heated to 140° F. for 30 minutes and then filtered through a pre-weighed Gooch crucible which was then dried in an oven at 110° C. for 30 minutes. The Gooch crucible was then re-weighed and it was determined that 99.67% of the wax had dissolved in the commercially available Baker Hughes composition. Filtering of the sample took approximately 10 minutes. The filtered solution was then cooled to 35° F. at which point the sample separated into two layers, one of the layers being primarily wax. This two phase mixture was filtered. It was found that 71.7% by weight of the wax remained in solution. However, it took 48 hours to filter.

### Example 10

As a comparison with the tests done in Example 9, 0.9086 g of wax was measured and placed in 100 ml of the composition of the present invention containing 33.3% by weight of d-limonene and 66.7% by weight LPA®-210 and identified as V003. The mixture was heated to 140° F. for 30 minutes. The sample was then filtered through a pre-weighed Gooch crucible and dried at 110° F. in an oven for 30 minutes. Following this, the Gooch crucible was weighed and it was found that 95.38% by weight of the wax had dissolved. Filtering of the sample took approximately 5 minutes. The filtered solution was cooled to 14° F. It was found that 81.8% of the wax remained in solution at that temperature and filtering took 1 hour. The results from Example 9 and 10 are shown in Table 9 below.

TABLE 9

| | | Heating | | Filtering | |
|---|---|---|---|---|---|
| Solvent | Sample Size | Time | % dissolved | Time | |
| Baker Hughes | 1.29 | 30 min. | 99.7 | 10 | minutes |
| V003 | .909 | 30 min. | 95.38 | 5 | minutes |

Filtered Baker Hughes Blend - after cooling to 35° F.

| | | | |
|---|---|---|---|
| Baker Hughes | 71.7¹ | 48 | hours |

Filtered V003 Blend - after cooling to 14° F.

| | | | | |
|---|---|---|---|---|
| Baker Hughes | Not tested | | | |
| V003 | | 81.8% | 1 | hour |

¹Sample separated into two phases - a liquid phase and a solid wax phase.

Comparing the results of Examples 9 and 10, it can be seen that the composition of the present invention is far more effective at low temperatures than a commercially available composition containing toluene in terms of keeping wax in solution.

### Example 11

Samples of wax and asphaltine were dissolved in 100 mm of toluene and kept at 73° F. for 60 minutes in a sonic bath. The results are shown in Table 11 below.

TABLE 10

| | | Percentage | | |
|---|---|---|---|---|
| | Sample weight | Dissolved | Filtering Time | |
| 1^{st} RUN | | | | |
| Asphalt | 0.9766 | 53.3% | 3 | hours |
| Wax | 1.3078 | 88.6% | 45 | minutes |
| 2^{nd} RUN | | | | |
| Asphalt | 1.0368 | 48.3% | 3 | hours |
| Wax | 1.91 | 89.8% | 45 | minutes |

### Example 12

The procedure of Example 11 was followed except the composition of the present invention containing 95% by weight d-limonene and 5% by weight LPA-210® was employed. The results are shown in Table 11 below.

TABLE 11

| | | Percentage | | |
|---|---|---|---|---|
| | Sample weight | Dissolved | Filtering Time | |
| Asphaltine | 0.9859 g | 41.5% | 2 | hours |
| Wax | 1.0434 g | 97.03% | 15 | minutes |

As can be seen by comparing the data from Tables 1.0 and 11, while the composition of the present invention is slightly less effective at dissolving asphaltines as compared with toluene, it effects the dissolution at a faster rate. With respect to wax and again comparing the data from Tables 10 and 11, it can be seen that the composition of the present invention is much more effective at dissolving wax and in a shorter time as compared with using toluene. It should also be noted that since the composition of the present invention contains low levels of aromatic, it is far safer than the commercial product of Example 9 or toluene alone.

While the compositions of the present invention have been described with reference only to the use of terpenes and hydrocarbon solvents, it is to be understood that the compositions can contain other components to treat specific problems. For example, in certain cases the compositions can include surfactants including cationic surfactants, anionic surfactants, non-ionic surfactants, etc. It is also possible to incorporate emulsifiers, alkaline builders, water-soluble solvents, such as glycol ethers, etc. Alkaline builders include hydroxides, carbonates, phosphates and silicates while suitable water soluble solvents include ethylene glycol, diethylene glycol, propylene glycol and di-propylene glycol ethers. In general surfactants such as alkyl phenol ethoxylates, linear alcohol ethoxylates, alkyl sulfonates, amphoterics and fatty acid soaps of alkanolamides can be used. Additionally, bacteriacides, scale inhibitors and other additives commonly used in downhole well treating can also be employed.

In using the composition of the present invention in downhole environments, i.e., in the formation and/or the production tubing, casing, etc., the composition alone or dissolved in hot oils can be injected into the well at elevated temperatures if desired.

The foregoing description and examples illustrate selected embodiments of the present invention. In light thereof, variations and modifications will be suggested to one skilled in the art, all of which are in the spirit and purview of this invention.

What is claimed is:

1. A composition for removing and/or controlling build-up of paraffin waxes and/or asphaltines from surfaces comprising:
from 1 to 99.9% by weight of a terpene selected from the group consisting of d-limonene, alpha-pinene, beta-pinene and mixtures thereof; and
from 0.1 to 99.8% by weight of a hydrocarbon solvent comprising from 60 to 70% by weight of a paraffin component, from 30 to 40% by weight of a naphthenic component and less than 2% by weight aromatics.

2. The composition of claim 1, wherein said paraffinic component contains at least 95% by weight isoparaffins.

3. The composition of claim 1, wherein said paraffinic component contains at least 98% isoparaffins.

4. The composition of claim 1, wherein said terpene is d-limonene.

5. The composition of claim 1, wherein said d-limonene is present in an amount of from about 35 to about 99.9% by weight and said hydrocarbon solvent is present in an amount of from about 0.1 to about 65% by weight.

6. The composition of claim 1, wherein said d-limonene is present in an amount of from about 20 to about 99.9 by weight and said hydrocarbon solvent is present in an amount of from about 0.1 to about 80% by weight.

7. The components of claim 6, wherein said d-limonene is present in an amount of from about 30 to about 99.1% by weight and said hydrocarbon is present in an amount of from about 0.1 to about 70% by weight.

8. The composition of claim 1, wherein said d-limonene is present in an amount of from about 25 to about 40% by weight and said hydrocarbon solvent is present in an amount of from about 60 to about 75% by weight.

9. A method for controlling and/or removing buildup of waxes and/or asphaltines derived from formation fluids comprising:
injecting into a wellbore a composition comprising:
from 0.1 to 99.9% by weight of a terpene selected from the group consisting of d-limonene, alpha-pinene, beta-pinene and mixtures thereof; and
from 0.1 to 99.9% by weight of a hydrocarbon solvent comprising from 60 to 70% by weight of a paraffin component, from 30 to 40% by weight of a naphthenic component and less than 2% by weight aromatics.

10. The method of claim 9, wherein said paraffinic component contains at least 95% by weight isoparaffins.

11. The method of claim 10, wherein said paraffinic component contains at least 98% isoparaffins.

12. The method of claim 9, wherein said terpene is d-limonene.

13. The method of claim 9, wherein said d-limonene is present in an amount of from about 35 to about 99.9% by weight and said hydrocarbon solvent is present in an amount of from about 0.1 to about 65% by weight.

14. The method of claim 9, wherein said d-limonene is present in an amount of from about 20 to about 99.9% by weight and said hydrocarbon solvent is present in an amount of from about 0.1 to about 80% by weight.

15. The method of claim 14, wherein said d-limonene is present in an amount of from about 30 to about 99.9% by weight and said hydrocarbon solvent is present in an amount of from at least 0.1 to about 70% by weight.

16. The method of claim 9, wherein said d-limonene is present in an amount of from about 25 to 40% by weight and said hydrocarbon solvent is present in an amount of from about 60 to about 75% by weight.
